(19) United States
(12) Patent Application Publication
(10) Pub. No.: US 2020/0064505 A1
(43) Pub. Date: Feb. 27, 2020

(54) NOVEL FREQUENCY-SHIFTING METHOD AND APPARATUS FOR CEMENT-BOND LOGGING

(71) Applicant: 4g Wireline Systems LLC, Granbury, TX (US)

(72) Inventors: Wade Maxfield, Granbury, TX (US); Bryant Tickell, Granbury, TX (US)

(73) Assignee: 4g Wireline Systems LLC, Granbury, TX (US)

(21) Appl. No.: 16/113,004

(22) Filed: Aug. 27, 2018

(51) Int. Cl. G01V 1/24; G01V 1/42; G01V 1/18; E21B 47/00; E21B 47/12

(52) U.S. Cl. CPC G01V 1/247; G01V 1/42; E21B 47/12; E21B 47/0005; G01V 1/18

(57) ABSTRACT

A frequency-shifting system and method for cement-bond-logging tools is disclosed. Shifting the frequency of a received acoustic signal to a lower signal for transmission on a wireline is accomplished by digitizing the received signal at a first sampling rate, storing the digitized data in memory, and converting the digitized data to an analog signal at a second sampling rate. The digitizing sampling rate is higher than the conversion sampling rate. This allows an acoustic operating frequency that is greater than the wireline transmission frequency, and therefore allow signal-to-noise optimization not available in conventional systems. Acoustic transducers can be operated at higher frequencies than what is acceptable for wireline transmission. This allows for the use of transducers not conventionally used in the art (such as piezoelectric stacks).

### BACKGROUND

This invention pertains generally to well-logging technology for acoustically determining the cement bond between casing and formation in a cased wellbore. More specifically, the invention pertains to cement-bond logging technology that enables in-situ data acquisition at a first acoustic frequency by a logging tool disposed in a wellbore and transmission of the acquired data at a different frequency.

As is well-known in the art, holes may be drilled into the ground to access fluid deposits (e.g., water, oil, and natural gas) in subterranean formations. Often, the boreholes are lined with a tubular casing and cement is injected into the annulus between the outer surface of the casing and the borehole wall. The cement serves a variety of purposes, such as structurally supporting the casing and isolating zones (e.g., to prevent unwanted migration of fluids into an aquifer).

Cement bond logging provides in situ measurement of characteristics of the cement in the annulus between casing and borehole wall. A typical cement-bond-logging tool utilizes acoustic transducers to measure travel or reflection characteristics of acoustic signals in the borehole environment. The basic approach is well-known in the art. See, e.g., U.S. Pat. Nos. 3,729,705, 4,685,092, 4,740,928, and 5,377,160; Wang, et al., Understanding Acoustic Methods for Cement Bond Logging, 139 Journal of Acoustic Society of America 2407-2416 (May 2016), available at https://doi.org/10.1121/1.4947511.

In operation, a cement-bond-logging tool may be disposed in the borehole at the end of a wireline. The wireline is attached at one end to the tool disposed in the borehole and at the other end to a surface system. The surface system is electrically connected to the borehole-disposed tool through the wireline and typically includes a power supply for powering the tool, a transceiver for communicating with the tool, and a computer for controlling the tool and collecting information from the tool. Between the tool and the surface system, the wireline is partly spooled on a winch. The winch is used to position the tool along the longitudinal axis of the borehole by spooling out line to allow the tool to go “deeper” or winding up line to move the tool “shallower.” (“Deeper” and “shallower” here refer to the length along the borehole's longitudinal axis from the surface. The borehole is not necessarily vertical.)

In typical operation, a transducer in a cement-bond-logging tool disposed within a borehole is electrically operated to produce an acoustic signal. The acoustic signal travels from the tool to the casing (and through the casing) and then back to the tool (along various paths). The tool receives the return acoustic signal through a transducer, converts the acoustic signal to an electric signal, performs some level of signal processing on the electric signal, and transmits the processed signal along the wireline to the surface system for recording and display. It is possible to infer information about the cement in the annulus from the return acoustic signal. For example, the quickest return path for the acoustic signal is typically through the casing (as opposed to, for example, the formation, the borehole fluid, or the tool housing). The better the bond between the cement and the casing, the less acoustic energy returned along the casing. Thus, one can infer information about the casing-cement bond from the amplitude of the beginning of the return acoustic signal: lower amplitude indicates a better bond. (If the formation path is faster than the casing path, then a higher amplitude at the beginning of the return signal indicates a better bond.)

Two connected issues that affect the quality of a cement-bond-logging tool are: (1) the signal-to-noise ratio at the tool and (2) the signal-to-noise ratio at the surface. The first issue is related to the operating frequency of the transducers. Receiving too far off the receiver's resonance (at other than the transducer's resonant frequency) can significantly lower the signal-to-noise ratio at the tool. A transducer's resonant frequency is generally inversely related to its size—the smaller the transducer the higher the resonant frequency. Thus, smaller transducers require higher operating frequencies. The second issue is also related to the operating frequency of the transducers. Generally, the greater the frequency of the signal transmitted along the wireline, the greater the transmission losses. The wireline losses for the received signal increase with transducer operating frequency.

These two issues can be in tension—a higher transducer operating frequency may improve the signal-to-noise ratio at the tool (because it is closer to the resonant frequency of the transducer) but will increase transmission losses. Conversely, a lower operating frequency may improve transmission losses, but at the cost of degraded signal at the tool. In effect, the wireline losses either impose a size constraint on the transducers or require operating transducers well above the resonant frequency. Often, the borehole operating environment imposes a transducer size constraint in tension with the wireline-loss size constraint: the borehole requires small transducers (to reduce the diameter of the tool) with resonant frequencies well above what is acceptable for wireline losses. This size constraint is exacerbated for multi-transmitter applications. The typical cement-bond-logging tool operates at around 20 kHz and surface systems often have limited ability to process cement-bond-logging signals of frequencies greater than about 25 kHz.

Accordingly, there is a need for technology to enable a higher transducer operating frequency to improve the signal-to-noise ratio at the tool without increasing the transmission losses along the wireline and while maintaining compatibility with existing surface systems. This would, for example, enable use of smaller, higher-frequency, transducer configurations than is the practice in the art of cement-bond logging. For example, instead of the transducers conventionally used in a cement-bond-tool, the frequency-shifting technology disclosed herein can allow the use of several small stacked piezo transducers azimuthally dispersed in transmitter-receiver pairs to provide high-quality azimuthal cement-bond information. (A stacked piezo transducer is comprised of several stacked layers of piezoelectric material.)

### SUMMARY

This invention includes technology for shifting the frequency of an electric signal generated in response to a received acoustic signal before driving the shifted-frequency signal on a wireline. This technology enables a novel cement-bond-logging tool that utilizes stacked piezoelectric transducers that operate at a much higher frequency than can be transmitted on the wireline.

In one aspect of the invention, a cement-bond-logging tool includes an acoustic transmitter and receiver, an analog-to-digital converter (ADC), a memory, a digital-to-analog converter (DAC), a digitizing clock, and a converting clock. The ADC converts the analog signal of the acoustic receiver to a digital signal which is stored in memory (at least in part). The digitizing clock sets the sampling rate for the ADC. The DAC converts the digital signal stored in memory to an analog signal. The converting clock sets the sampling rate for the DAC. The sampling rate for the ADC is different from the sampling rate for the DAC. Thus, in operation, an acoustic signal received at the receiver is frequency shifted through the ADC/DAC conversions. The receiver or transmitter may be a piezoelectric stacked transducer

In another aspect of the invention, a cement-bond-logging tool includes a transmitting acoustic transducer configured to generate an acoustic pulse, a receiving acoustic transducer configured to generate an electric signal in response to receipt of an acoustic signal, and a circuit for shifting the frequency the electric signal generated by the receiving transducer. In operation, the transmitting transducer produces an acoustic pulse having a first frequency, the acoustic pulse travels through a borehole environment, the receiving transducer generates an electric signal having the first frequency in response to the receipt of the transmitted acoustic pulse, and the circuit shifts the first frequency to a second frequency. Typically, the second frequency is lower than the first frequency to enable smaller or higher-frequency transducers (e.g., piezoelectric stack transducers) and lower transmission losses when transmitting the electric signal to, e.g., a system for analysis, display, or storage.

In another aspect of the invention, a method for determining the quality of a bond between cement and casing includes placing an acoustic transmitter and receiver in a borehole, operating the transmitter to generate an acoustic pulse, operating the receiver to generate a signal in response to receipt of the acoustic pulse as transmitted through a borehole environment, digitizing the receiver signal at a first rate, converting the digitized signal to an analog signal at a second rate (thereby shifting the frequency of the signal), and driving the analog signal on a wireline. Typically, the second rate is lower first rate to enable smaller or higher-frequency transducers (e.g., piezoelectric stack transducers) and lower transmission losses when transmitting the electric signal to, e.g., a system for analysis, display, or storage. In a further aspect of the invention, the analog signal may be extracted from the wireline and its frequency may be shifted before analysis, display, or storage of the signal. In a further aspect of the invention, a portion of the receiver signal may be discarded before digitization or before converting the digitized signal to the analog signal. The discarded portion may be replaced before analysis, display, or storage of the signal.

### BRIEF DESCRIPTION OF THE DRAWINGS

These and other features, aspects, and advantages of the present invention will become better understood with reference to the following description, appended claims, and accompanying drawings where:

FIGS. 1A-1B illustrate an exemplary cement-bond-logging tool disposed in a borehole.

FIG. 2 illustrates an exemplary cement-bond-logging tool disposed in a borehole and exemplary acoustic-signal paths through the borehole environment.

FIGS. 3A-3B illustrate an exemplary cement-bond-tool configuration having a single acoustic transmitter and a single acoustic receiver.

FIGS. 4A-4B illustrate an exemplary cement-bond-tool configuration having multiple acoustic transmitters and multiple acoustic receivers.

FIG. 5 illustrates three idealized representations of an amplitude-versus-time profile for acoustic signals traveling various paths through the borehole environment.

FIG. 6 illustrates an exemplary system for shifting the frequency of a received acoustic signal to a lower frequency for transmission on a wireline.

FIG. 7 illustrates two idealized representations of an amplitude-versus-time profile for a received acoustic signal as it is processed at two points in the processing: (1) as converted to digital form by an ADC, and (2) as converted back to an analog form, but at a lower frequency, by a DAC.

FIG. 8 illustrates two idealized representations of an amplitude-versus-time profile for a received acoustic signal as it is processed at two points in the processing: (1) as converted to digital form by an ADC, and (2) as converted back to an analog form, but at a lower frequency and truncated, by a DAC.

FIG. 9 illustrates an exemplary cement-bond-log presentation of data from a prior-art cement-bond-log tool incorporating transducers operating at about 20 kHz.

FIG. 10 illustrates an exemplary cement-bond-log presentation of data from a cement-bond-log tool incorporating transducers operating at about 125 kHz.

### DETAILED DESCRIPTION

In the summary above, and in the description below, reference is made to particular features of the invention in the context of exemplary embodiments of the invention. The features are described in the context of the exemplary embodiments to facilitate understanding. But the invention is not limited to the exemplary embodiments. And the features are not limited to the embodiments by which they are described. The invention provides a number of inventive features which can be combined in many ways, and the invention can be embodied in a wide variety of contexts. Unless expressly set forth as an essential feature of the invention, a feature of a particular embodiment should not be read into the claims unless expressly recited in a claim.

Except as explicitly defined otherwise, the words and phrases used herein, including terms used in the claims, carry the same meaning they carry to one of ordinary skill in the art as ordinarily used in the art.

Because one of ordinary skill in the art may best understand the structure of the invention by the function of various structural features of the invention, certain structural features may be explained or claimed with reference to the function of a feature. Unless used in the context of describing or claiming a particular inventive function (e.g., a process), reference to the function of a structural feature refers to the capability of the structural feature, not to an instance of use of the invention.

Except for claims that include language introducing a function with “means for” or “step for,” the claims are not recited in so-called means-plus-function or step-plus-function format governed by 35 U.S.C. § 112(f). Claims that include the “means for [function]” language but also recite the structure for performing the function are not means-plus-function claims governed by § 112(f). Claims that include the “step for [function]” language but also recite an act for performing the function are not step-plus-function claims governed by § 112(f).

Except as otherwise stated herein or as is otherwise clear from context, the inventive methods comprising or consisting of more than one step may be carried out without concern for the order of the steps.

The terms “comprising,” “comprises,” “including,” “includes,” “having,” “haves,” and their grammatical equivalents are used herein to mean that other components or steps are optionally present. For example, an article comprising A, B, and C includes an article having only A, B, and C as well as articles having A, B, C, and other components. And a method comprising the steps A, B, and C includes methods having only the steps A, B, and C as well as methods having the steps A, B, C, and other steps.

Terms of degree, such as “substantially,” “about,” and “roughly” are used herein to denote features that satisfy their technological purpose equivalently to a feature that is “exact.” For example, a component A is “substantially” perpendicular to a second component B if A and B are at an angle such as to equivalently satisfy the technological purpose of A being perpendicular to B.

Except as otherwise stated herein, or as is otherwise clear from context, the term “or” is used herein in its inclusive sense. For example, “A or B” means “A or B, or both A and B.”

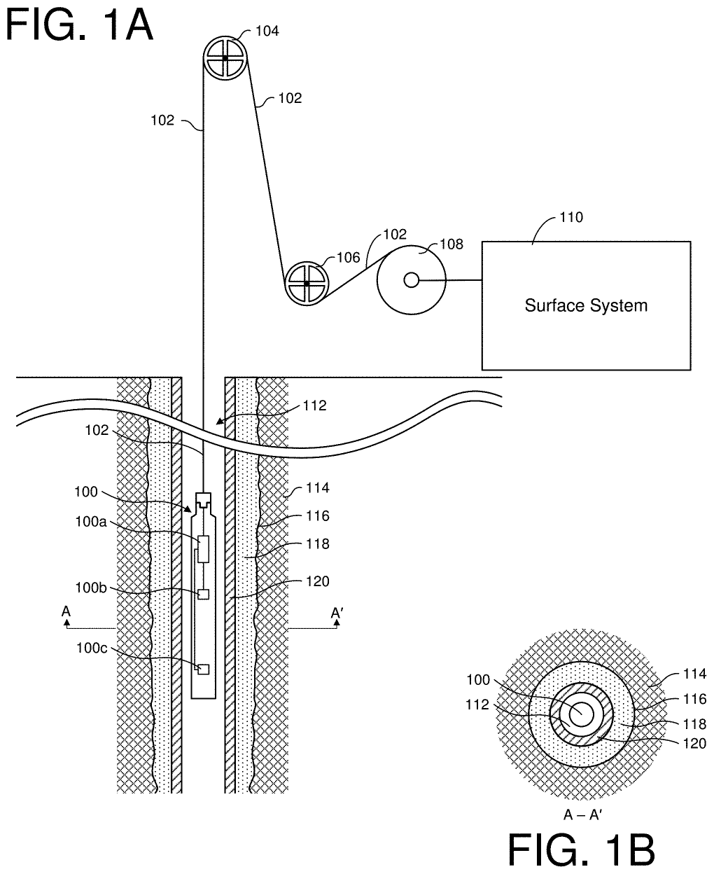

An exemplary cement-bond-logging tool 100 as disposed in a borehole and connected to a surface system 110 via a wireline 102 is illustrated in FIGS. 1A and 1B. A borehole penetrating a formation 114 is defined in part by the borehole wall 116. The borehole is lined with casing 120 and cement 118 is injected into the annulus between the casing 120 and the borehole wall 116. The portion of the borehole within the interior diameter of the casing is filled with a fluid 112 (which may include fluids from the formation, such as water, oil, and natural gas). The tool 100 is lowered into the borehole at the end of the wireline 102 using a winch 108 and a series of sheaves 104, 106. The tool 100 is connected to the surface system 110 through the wireline 102. The surface system 110 is operated to control the tool 100 to acquire data while the tool 100 is disposed in the borehole.

The cement-bond-logging tool 100 includes an electronics section 100a, an acoustic transmitter 100b, and an acoustic receiver 100c. The acoustic transmitter 100b generates an acoustic signal that travels through the borehole environment to return to the tool 100 where it is detected at the acoustic receiver 100c. The acoustic receiver 100c receives the return signal. Typically, the transmitter 100b and receiver 100c are piezoelectric transducers that convert electrical energy into mechanical vibration (the transmitter) and mechanical vibration into electrical energy (the receiver). The transmitter 100b is coupled to the borehole fluid 112 such that application of an electrical signal to the transmitter, which causes the transmitter 100b to vibrate, will generate a wave in the borehole fluid 112 (the acoustic signal). The receiver 100c is coupled to the borehole fluid 112 such that it will vibrate in response to a wave in the borehole fluid 112. The electronics section 100a includes: (1) circuitry for operating the transmitter 100b (e.g., applying the electrical signal to generate the acoustic signal), (2) circuitry for operating the receiver 100c (e.g., receiving the return acoustic signal to generate a return electrical signal), (3) circuitry for processing the return electrical signal, and (4) circuitry for communicating with the surface system 110 (e.g., to enable the surface system 110 to control operation of the transmitter 100b and receiver 100c and to collect the return electrical signal or a representation thereof).

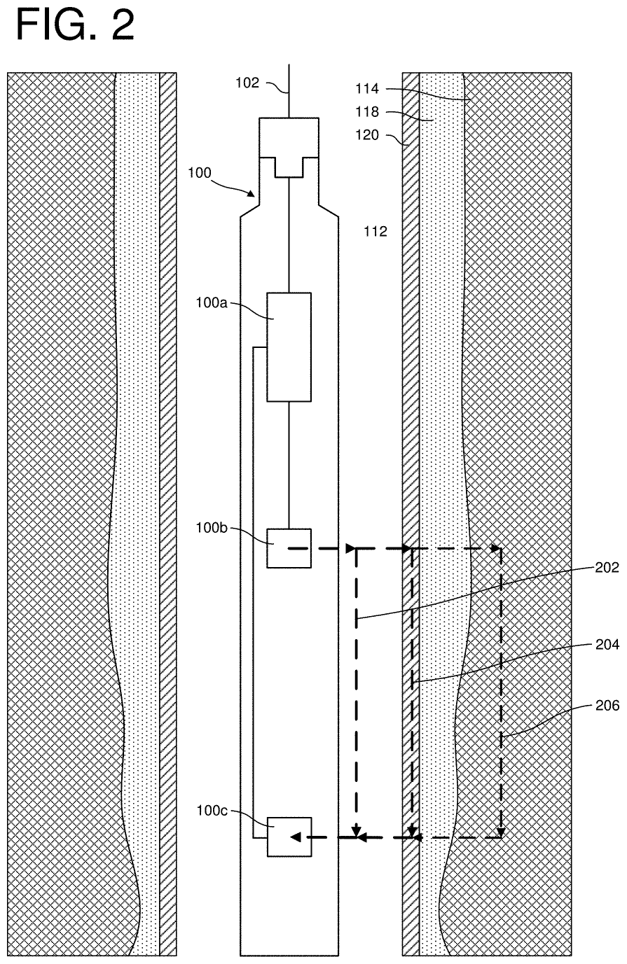

FIG. 2 illustrates various paths 202, 204, 206 the acoustic signal generated by the transmitter 100b may travel from the transmitter 100b to return to the tool 100 at the receiver 100c. A portion (all or some) of the acoustic signal may travel along: (1) a path 202 through the borehole fluid 112, (2) a path 204 through the casing 120, or (3) a path 206 through the formation 114. The amount of energy in the portion of the signal in the casing path 204 depends in part on the bond between the casing 204 and the cement 118. A good bond leaves less acoustic energy in the casing path 204.

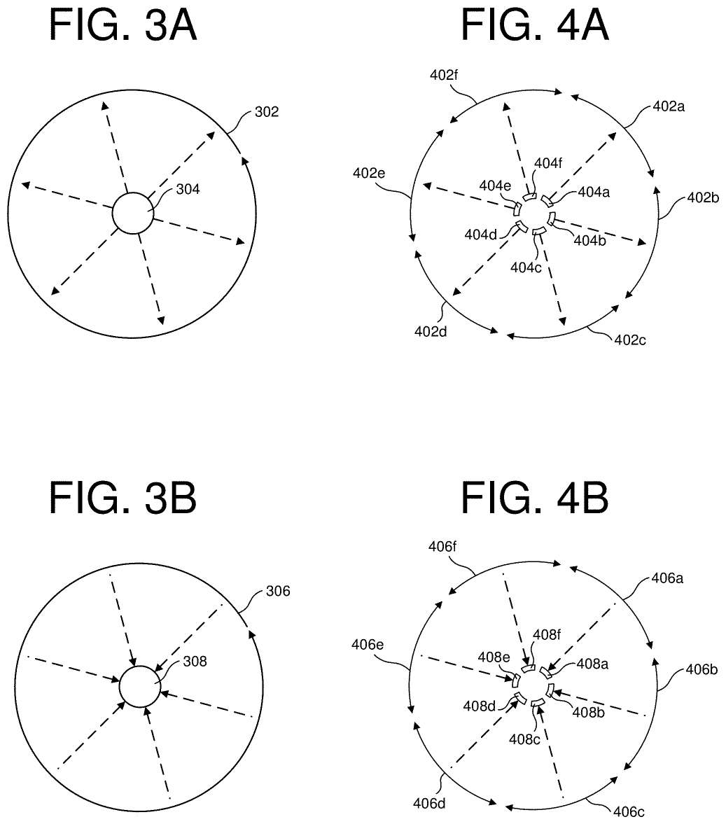

The paths in FIG. 2 are illustrated for only one portion of the borehole for ease of explanation. In practice, the azimuthal extents and positions of the paths vary with the type of bond tool/transducer design. Some tools are designed to transmit and receive over substantially 360 degrees of azimuth (the angular direction around the longitudinal axis of the tool). Other tools are designed with segmented transducers that transmit or receive for smaller azimuthal sectors. For example, a transmitter 304 and receiver 306 pair depicted in FIGS. 3A-3B are configured to transmit and receive over substantially 360 degrees of azimuth, respectively. The dashed arrows indicate a direction of propagation of the acoustic signal. The solid circular arrows indicate azimuth of transmission 302 and reception 306. The transmitter/receiver pairs depicted in FIGS. 4A-4B are segmented. There are six transmitters 404a, 404b, 404c, 404d, 404e, 404f, each configured to transmit in an azimuthal sector of about 60 degrees 402a, 402b, 402c, 402d, 402e, 402f. There are six receivers 408a, 408b, 408c, 408d, 408e, 408f, each configured to receive from an azimuthal sector of about 60 degrees 406a, 406b, 406c, 406d, 406e, 406f. In practice, the number of azimuthal sectors, and the azimuthal overlap between sectors, is a factor of tool design. And is possible to combine 360-degree transmitters or receivers with segmented transmitters or receivers.

The cement-bond-logging tool 100 depicted in FIGS. 1 and 2 has one transmitter and one receiver. In practice, tools may have multiple transmitters or receivers. For example, a common tool configuration is to have one transmitter, a first receiver spaced at 3 feet from the transmitter, and a second receiver spaced at 5 feet from the transmitter.

In the typical operation of a cement-bond-logging tool, an electrical signal causes the transmitter to generate an acoustic pulse having a predetermined frequency (e.g., 20 kHz). The acoustic pulse will travel from the tool into the borehole environment causing various components to vibrate at the frequency of the pulse. This acoustic energy will travel through the borehole environment (e.g., borehole fluid, casing, cement, formation) and return to the receiver. The receiver vibrates at the frequency of the pulse and thereby generates and electrical signal at that frequency. The duration of the received signal depends on the extent to which the borehole components ring. Typically, the duration of the received signal is about 5-25 milliseconds. The transmit-receive cycle is repeated as the tool moves through the hole (e.g., as the winch winds the wireline in and raises the tool to the surface).

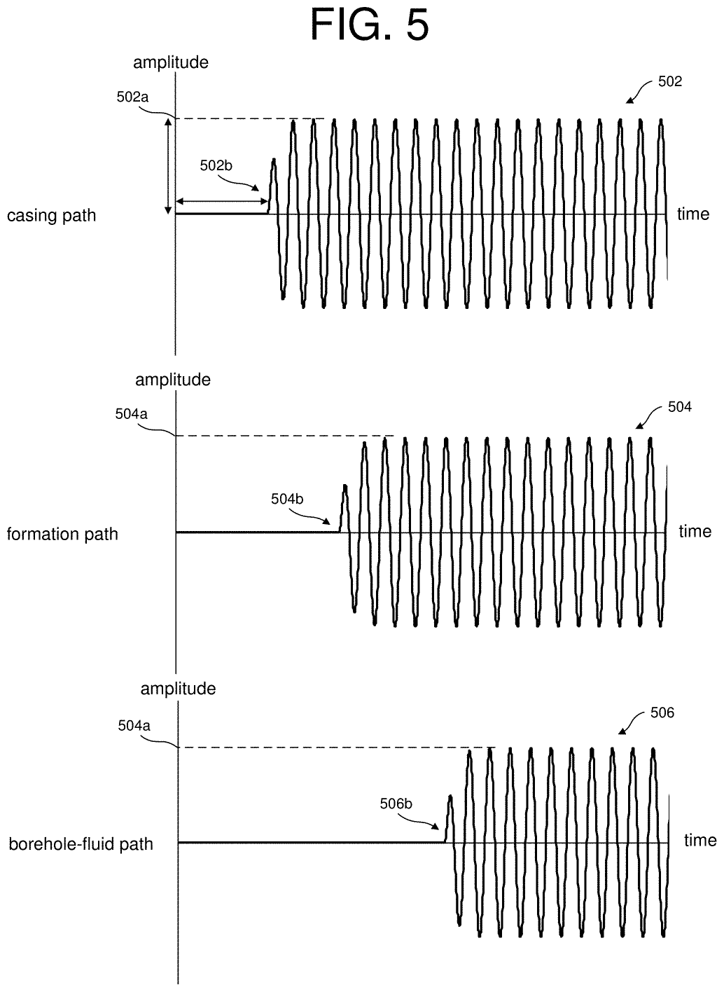

Three idealized curves representing the acoustic signals received at the tool (and converted to electric signals through the receiving transducer) are presented in FIG. 5, one for each of the paths depicted in FIG. 2. The amplitude is on the ordinate axis (vertical) and time is on the abscissa axis (horizontal). The received signal for the casing path 502 has a characteristic amplitude 502a and arrival time 502b (the time from initiation of the transmitter pulse to the first return to the receiver). The received signal for the formation path 504 has a characteristic arrival time 504b that is shown here greater than the casing arrival time 502b. (For some formations, the formation arrival may precede the casing arrival.) The received signal for the borehole-fluid path 506 has a characteristic arrival time 506b shown here greater than the casing arrival time 502b and the formation arrival time 504b.

The amplitude 502a of the received casing-path signal 502 is a function of the bond between the casing and the cement in the annulus between the casing and the borehole wall. The better the bond, the more acoustic energy that is transmitted through the casing and the lower the amplitude 502a. The worse the bond, the more acoustic energy that remains in the casing path and the higher the amplitude 502a. The amplitude 502a, as registered by the receiver, is also a function of the amplitude of the signal produced by the transmitter and the receiver's ability to convert the acoustic energy to electrical energy. These, in turn, are functions of the frequency of the signal. Generally, smaller transducers perform better at higher frequencies.

The amplitude of the received formation-path signal 504 also provides information indicative of cement-bond quality. For example, the better the bond between the cement and the formation the more acoustic energy travels through the formation and the greater the amplitude of the received formation-path signal 504.

Ideally, the cement-bond-logging tool will capture the return signal through at least the borehole-fluid arrival time 506b. And it will send this signal to the surface system 110 via the wireline. In practice, it is common to capture about 2 milliseconds of the return signal (measured from the firing pulse of the transmitter).

Because of wireline losses, it is difficult to send a return signal to the surface system 110 when the frequency of the signal is much above 20 kHz. As a result, for higher frequency operation, e.g., at 100-120 kHz, it is typically the envelope of the signal that is captured and returned as opposed to the signal itself. This does not provide the same information as the full signal.

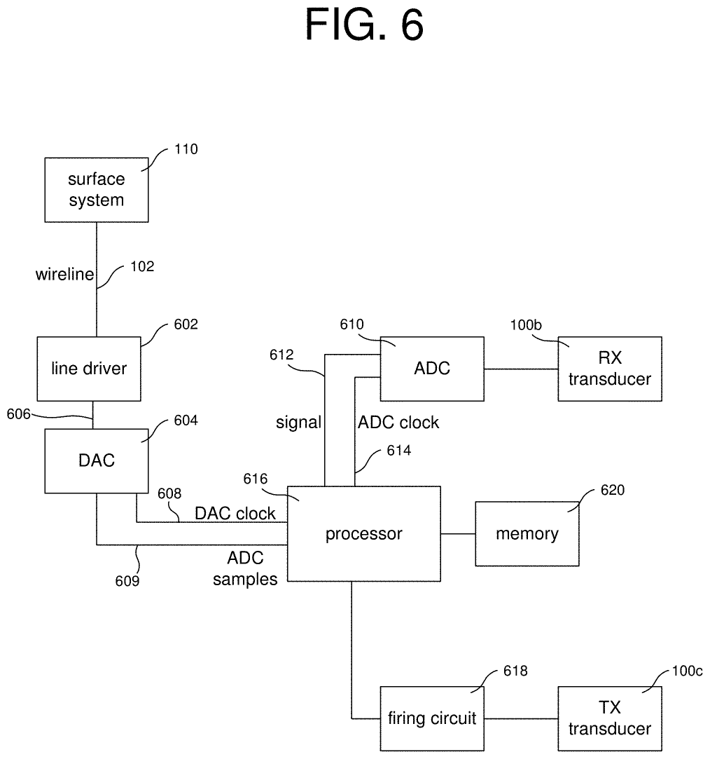

FIG. 6 depicts an exemplary system (in part, the electronics section 100a of FIG. 1) for sending the return signal (rather than its envelope) to the surface system for signal frequencies that would otherwise be lost due to wireline losses. This enables a more robust waveform analysis of cement-bond-logging signals at higher frequencies than does sending only the envelope of the return signal. Thus, it enables the use of atypical cement-bond-logging-tool transducers. For example, the frequency-shifting technology disclosed herein has enabled the use of small piezoelectric stack actuators as acoustic transducers in a cement-bond-logging tool. (Examples of piezoelectric stack actuators can be found at https://www.americanpiezo.com/standard-products/stack-actuators.html.)

A processor 616 controls firing circuit 618 to supply a high voltage pulse (e.g., 1000 VDC) to a transmitter transducer 100c. The transmitter transducer 100c vibrates in response to the pulse and produces acoustic energy with a frequency of about 120 kHz. The 120 kHz acoustic energy travels through the borehole environment to be received at a receiver transducer 100b that converts the acoustic signal to an electrical signal. The processor 616 controls an analog-to-digital converter (ADC) 610 to sample the electrical signal from the receiver 100b at a sampling period defined by an ADC clock 614 provided by the processor (e.g., 1 million samples per second). Typically, the ADC clock starts a substantially the same time as the firing pulse (within about 5-10 nanoseconds). The processor 616 stores the sampled signal 612 from the ADC 610 in memory 620.

The processor 616 controls a digital-to-analog converter (DAC) 604 to convert the sampled receiver signal stored in memory 620 to an analog signal 606 provided to the line driver 602 at a sampling period defined by a DAC clock 608. The DAC 604 provides the analog signal 606 to a line driver 602 that provides the signal to the surface system 110 through the wireline 102. The DAC clock 608 is slower than the ADC clock 614 and is chosen so that wireline losses are acceptable, for example, the DAC clock 608 may operate at 168 thousand samples per second to simulate a signal of about 22 kHz.

The various electronic components of the system illustrated in FIG. 6 are shown as separate. In practice, the components may be consolidated into fewer devices than shown. For example, as is well-known in the art, it is common to combine ADC, DAC, processor, and memory into a single device.

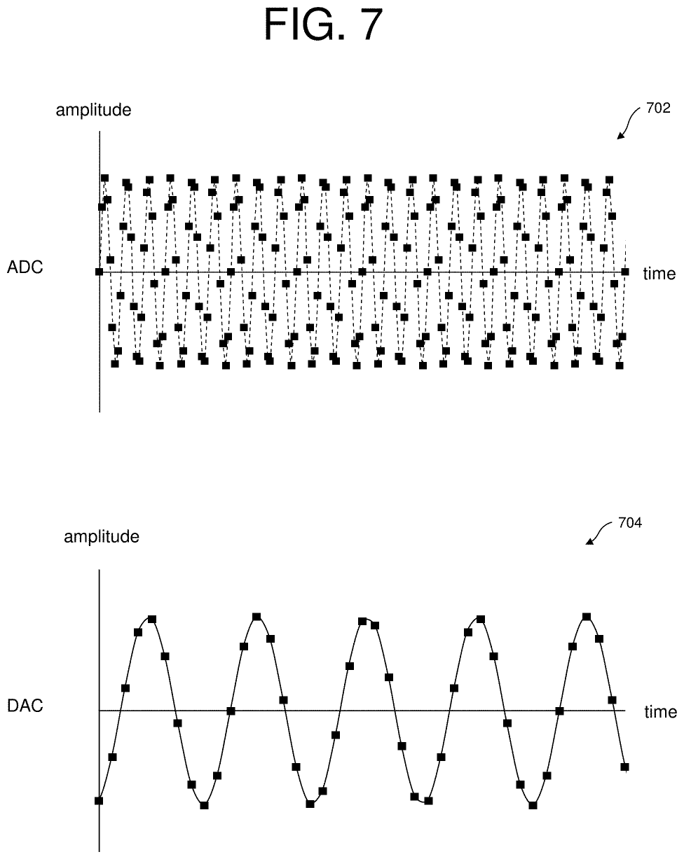

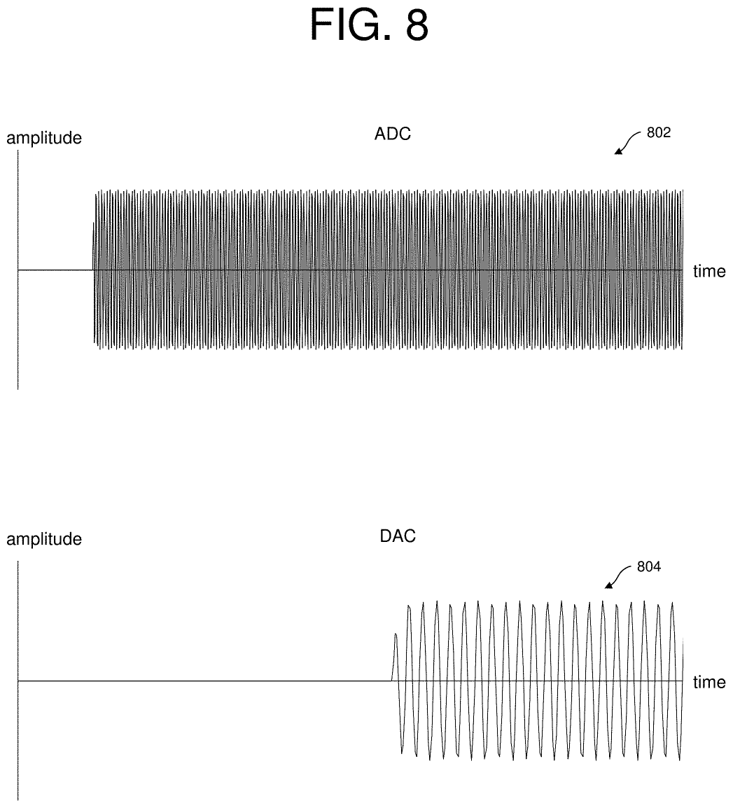

FIGS. 7 and 8 depict portions of an idealized ADC output signal 702 and an idealized DAC output signal 704. The ADC signal 702 consists of samples taken at 1 million samples per second (the digital ADC signal 702 is represented by the markers, the analog line is shown for illustrative purposes). A portion of the ADC signal 702 is clocked out of the DAC at 168 thousand samples per second to generate the DAC signal 704 having a frequency of about 22 kHz (the analog DAC signal 704 is represented by the line, the digitized samples are shown for illustrative purposes). The 22 kHz DAC signal 704 is ultimately sent to the surface via the wireline.

As illustrated in FIG. 8, for an ADC signal 802 of 2 milliseconds, a corresponding 2 millisecond DAC signal 804 is truncated—it does not include the entire 2 milliseconds of ADC signal 802. For multi-receiver tools, it may not be possible to send more than 2 milliseconds of DAC signal 804 from a given receiver because each receiver must be allowed time on the wireline. In this case, the DAC signal 804 will include only a portion of the ADC signal 802. For example, the DAC signal 804 will include only about the first 333 microseconds of the ADC signal 802. To account for this—and allow formation-path or borehole-fluid-path signals to be captured and sent up the wireline—the early samples of the ADC output signal may be discarded and therefore not included in the DAC signal. For example, the first 150 microseconds of ADC samples (relative to the transmitter firing pulse) may be discarded assuming the first arrival at the receiver is after 150 microseconds. How much of the DAC signal is discarded is a function of the earliest likely arrival time of the return acoustic signal.

At the surface system 110, the signal is corrected for the difference in ADC clock and DAC clock and for any discarded samples from the ADC signal. The resultant signal provides travel time and amplitude information for an operating acoustic frequency higher than what would be achievable if the signal was not frequency shifted (because of wireline losses). And it provides more information than is provided when only the envelope of the signal is provided by the cement-bond-logging tool.

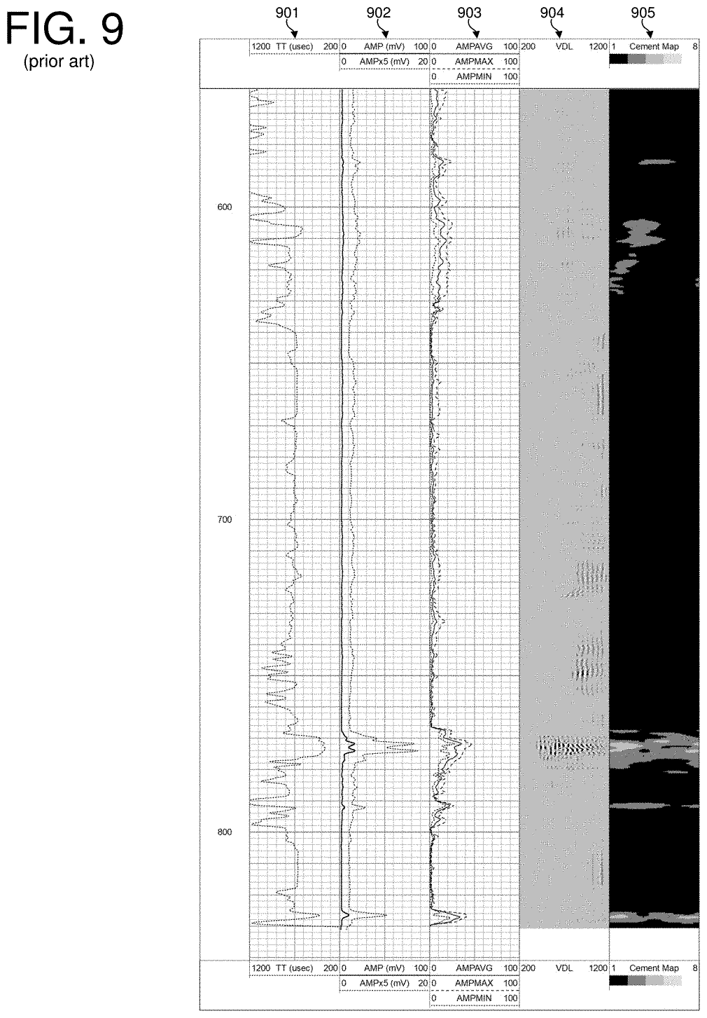

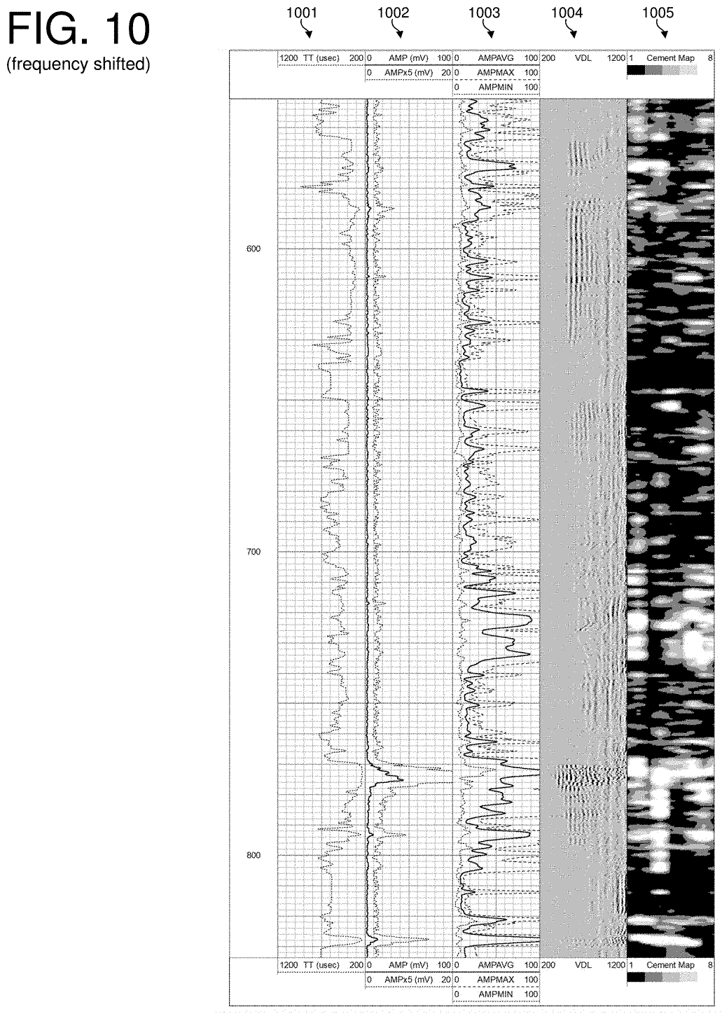

Exemplary cement-bond-log presentations are shown in FIGS. 9 and 10. FIG. 9 presents data acquired with a conventional azimuthally-segmented cement-bond-logging tool, operating at a frequency of about 20 kHz. FIG. 10 presents data acquired with a cement-bond-logging-tool including the frequency-shifting technology and piezo stack transducers (piezo stack actuators configured as transducers). Various information related to the received acoustic signal(s) is displayed as a function of depth in the borehole (the vertical axis). There are five tracks in the presentation in FIG. 9: a travel-time track 901, an amplitude-magnitude track 902, an amplitude-range track 903, a variable-density track 904, and an azimuthal-cement-bond-map track 905. Figure ten has the same tracks 1001, 1002, 1003, 1004, 1005. The presentation in the azimuthal-cement-bond-map tracks 905, 1005 represents the quality of the casing-cement bond at various azimuthal positions around the borehole. More specifically, the map brightness represents the amplitude of the first acoustic arrivals for the various receivers. The map is segmented horizontally, with each segment representing a receiver, and smoothed together for the display as is conventional in the art. The lower the amplitude of the first acoustic arrival, the darker the map display. The lighter sections, which correlate to higher amplitudes, represents areas of potentially poor cement-casing bond. Often, conventional tools will miss segments (or channels) of poor bond. This failure is often due to a poor signal-to-noise ratio. As shown in FIGS. 9 and 10, the frequency-shifting tool identifies more potential poor-bond segments than does the conventional tool.

While the foregoing description is directed to the preferred embodiments of the invention, other and further embodiments of the invention will be apparent to those skilled in the art and may be made without departing from the basic scope of the invention. And features described with reference to one embodiment may be combined with other embodiments, even if not explicitly stated above, without departing from the scope of the invention. The scope of the invention is defined by the claims which follow.

The invention claimed is:

1. A cement-bond-logging tool comprising:
(a) an acoustic transmitter transducer;
(b) an acoustic receiver transducer;
(c) an analog-to-digital converter configured to digitize signals generated by the acoustic receiver transducer;
(d) a memory configured to store digitized signals generated by the analog-to-digital converter;
(e) a digital-to-analog converter configured to convert digitized signals stored in the memory to analog signals;
(f) a digitizing clock; and
(g) a converting clock;
(h) wherein the digitizing clock is configured to establish a sampling rate for the analog-to-digital converter;
(i) wherein the converting clock is configured to establish a sampling rate for the digital-to-analog converter; and
(j) wherein the sampling rate for the analog-to-digital converter differs from the sampling rate for the digital-to-analog converter.

2. The cement-bond-logging tool of claim 1 wherein the acoustic receiver transducer is a piezoelectric stack.

3. The cement-bond-logging tool of claim 1 wherein the sampling rate for the analog-to-digital converter is greater than the sampling rate for the digital-to-analog converter.

4. The cement-bond-logging tool of claim 1 wherein the sampling rate for the digital-to-analog converter is configured to cause the digital-to-analog converter to generate analog signals having a frequency between 16 and 25 kHz.

5. A cement-bond-logging tool comprising:
(a) a first piezoelectric transducer configured to transmit an acoustic pulse at a first frequency;
(b) a second piezoelectric transducer configured to receive the acoustic pulse transmitted by the first piezoelectric transducer and to generate an electric signal having a frequency equal to the first frequency; and
(c) a means to shift the frequency of the electric signal that is generated by the second piezoelectric transducer.

6. The cement-bond-logging tool of claim 5 wherein the means to shift the frequency of the electric signal that is generated by the second piezoelectric transducer shifts the frequency to a lower frequency than the first frequency.

7. A method for determining the quality of a casing-cement bond, the method comprising:
(a) disposing in a borehole an acoustic transmitter and an acoustic receiver;
(b) generating a transmit acoustic signal with the acoustic transmitter;
(c) receiving a return acoustic signal with the acoustic receiver, wherein the return acoustic signal represents the transmit acoustic signal having passed through a borehole environment;
(d) digitizing the return acoustic signal at a digitizing rate;
(e) converting the digitized return acoustic signal to an analog signal at a converting rate, wherein the converting rate is different from the digitizing rate; and
(f) driving the analog signal on a wireline.

8. The method of claim 7 wherein the converting rate is lower than the digitizing rate.

9. The method of claim 7 wherein the acoustic receiver is a piezoelectric stack.

10. The method of claim 7 wherein:
(a) the transmit acoustic signal has a frequency greater than 100 kHz; and
(b) the analog signal has a frequency between 16 and 25 kHz.

11. The method of claim 7 further comprising:
(a) extracting the analog signal off the wireline;
(b) shifting a frequency of the extracted analog signal to a frequency of the transmit acoustic signal.

12. The method of claim 7 further comprising:
(a) deleting a first portion of the analog signal before driving the analog signal on a wireline;
(b) extracting the analog signal off the wireline; and
(c) adding to the extracted analog signal a replacement for the deleted first portion of the analog signal.

13. The method of claim 7 further comprising:
(a) deleting a first portion of the digitized return acoustic signal before converting the digitized return acoustic signal to an analog signal;
(b) extracting the analog signal off the wireline; and
(c) adding to the extracted analog signal a replacement for the deleted first portion of the digitized return acoustic signal.
